(19) United States
(12) Patent Application Publication
(10) Pub. No.: US 2015/0105134 A1
(43) Pub. Date: Apr. 16, 2015

(54) SYSTEMS AND METHODS FOR A COMBINATION LOTTERY AND FANTASY SPORTS LEAGUE

(71) Applicant: SkyBoxx Sports, LLC, Atlanta, GA (US)

(72) Inventors: Timothy F. S. Cobb, Atlanta, GA (US); Anthony S. Oddo, Boston, MA (US)

(21) Appl. No.: 14/579,876

(22) Filed: Dec. 22, 2014

Related U.S. Application Data
(63) Continuation of application No. 13/447,712, filed on Apr. 16, 2012.

(51) Int. Cl. G07F 17/32; A63F 13/828

(52) U.S. Cl. CPC G07F 17/329; G07F 17/3244; A63F 13/828
USPC 463/18

(57) ABSTRACT

Embodiments of the present invention may provide systems and methods for a lottery game combined with a fantasy sports league. The method may include receiving selections for multiple participant categories from a user, wherein the multiple participant categories are related to one or more statistical performance measurements for a participant in a future sporting event; converting the selections into numerical lottery numbers; comparing the numerical lottery numbers to actual statistical performances after a sporting event; determining, based on the comparing, if there is at least one winner; and assigning at least one prize to the at least one winner if there is at least one winner.

### CROSS-REFERENCE TO RELATED APPLICATIONS

This application is a continuation of U.S. Patent Application No. 13/447,712 filed Apr. 16, 2012, the contents of which is incorporated by reference herein in its entirety.

### FIELD OF THE INVENTION

The present invention relates to the field of lottery and fantasy sports leagues. More specifically, the present invention relates to systems and methods combining various aspects of lotteries and fantasy sports.

### BACKGROUND OF INVENTION

Both lotteries and fantasy sports leagues are popular forms of entertainment. Existing systems are exclusive to either lottery games or fantasy sports leagues. Combining certain aspects of lotteries with aspects of fantasy sports leagues may provide an exciting new game that appeals to a new or extended pool of users. For example, incorporating aspects of fantasy sports into a lottery game may appeal to moderate to serious sports fans that were not previously interested in lotteries.

### SUMMARY OF INVENTION

Embodiments of the present invention may provide systems and methods for a lottery game combined with a fantasy sports league. The method may include receiving selections for multiple participant categories from a user, wherein the multiple participant categories are related to one or more statistical performance measurements for a participant in a future sporting event; converting the selections into numerical lottery numbers; comparing the numerical lottery numbers to actual statistical performances after a sporting event; determining, based on the comparing, if there is at least one winner; and assigning at least one prize to the at least one winner if there is at least one winner.

Additional features, advantages, and embodiments of the invention are set forth or apparent from consideration of the following detailed description, drawings and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detailed description serve to explain the principles of the invention. While these drawings only show a particular embodiment, for that embodiment they are roughly drawn to scale.

FIG. 1 shows an exemplary system for a combination lottery and fantasy sports league in a networked computing environment.

FIG. 2 shows an exemplary server for a combination lottery and fantasy sports league in a networked computing environment.

FIG. 3 shows an exemplary process for a combination lottery and fantasy sports league.

### DETAILED DESCRIPTION OF THE EMBODIMENTS

Systems and methods are described for a combination lottery and fantasy sports league. The examples described herein relate to lottery systems for illustrative purposes only. The systems and methods described herein may be used for many different purposes, including, for example, the gaming industry and many others.

Although not required, the systems and methods are described in the general context of computer program instructions executed by one or more computing devices. Computing devices typically include one or more processors coupled to data storage for computer program modules and data. Key technologies include, but are not limited to, the multi-industry standards of MICROSOFT Operating Systems, SQL Server, .NET Framework (VB.NET, ASP.NET, AJAX.NET, etc.), ORACLE database BIEE products, other e-Commerce products and computer languages. Such program modules generally include computer program instructions such as routines, programs, objects, components, etc., for execution by the at least one processor to perform particular tasks, utilize data, data structures, and/or implement particular abstract data types. While the systems, methods, and apparatus are described in the foregoing context, acts and operations described hereinafter may also be implemented in hardware.

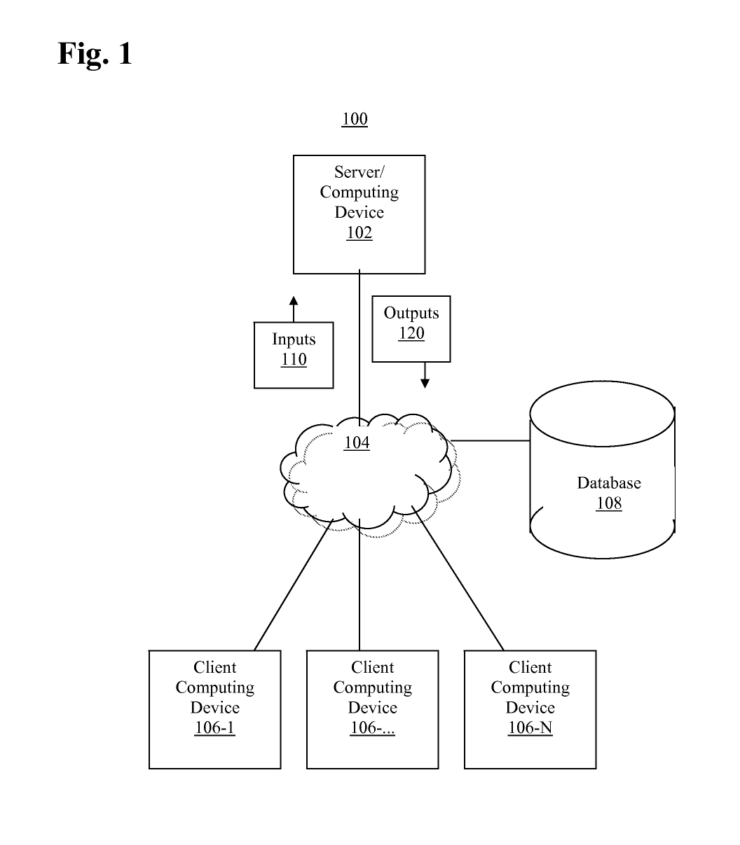

FIG. 1 shows an exemplary system 100 for a combination lottery and fantasy sports league, according to one embodiment. In this exemplary implementation, system 100 includes server/computing device 102 operatively coupled over network 104 to one or more client computing devices 106 (e.g., 106-1 through 106-N) and one or more databases 108. Server/computing device 102 represents, for example, any one or more of a server, a general-purpose computing device such as a server, a personal computer (PC), a laptop, and/or so on. Networks 104 represent, for example, any combination of the Internet, local area network(s) such as an intranet, wide area network(s), and/or so on. Such networking environments are commonplace in offices, enterprise-wide computer networks, etc. Client computing devices 106, which may include at least one processor, represent a set of arbitrary computing devices executing application(s) that respectively send data inputs 110 to server/computing device 102 and/or receive data outputs 120 from server/computing device 102. Such computing devices include, for example, one or more of desktop computers, laptops, mobile computing devices (e.g., PDAs), server computers, and/or so on. In this implementation, the input data comprises, for example, data hierarchy, data files, due dates, and/or so on, for digital file association with system 100. In one implementation, the data outputs include, for example, a current valuation, future valuation, and/or so on. Embodiments of the present invention may also be used for collaborative projects with multiple users logging in and performing various operations on a data project from various locations. Embodiments of the present invention may be web-based.

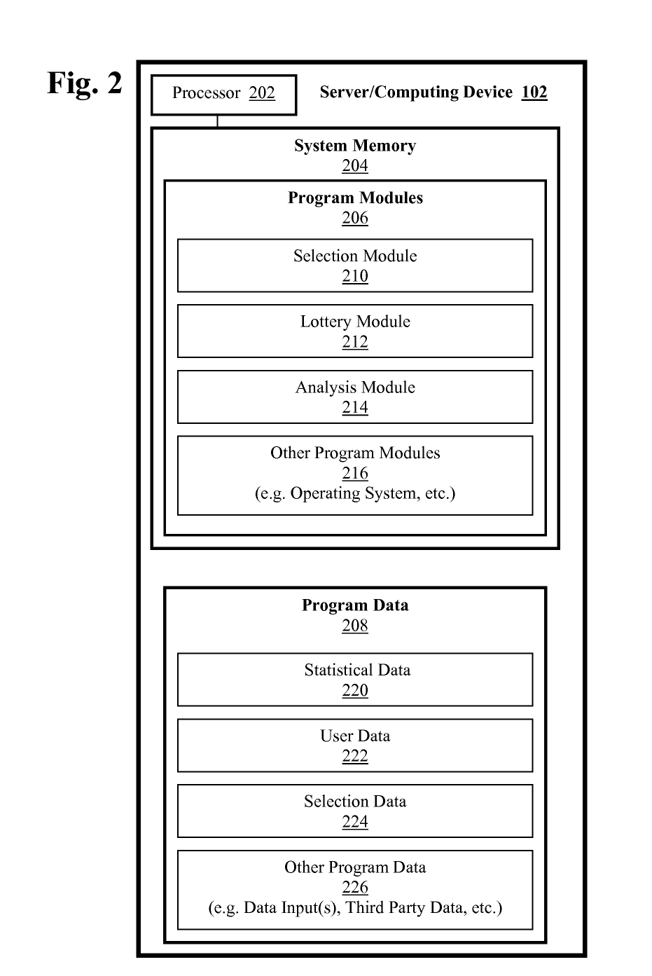

In this exemplary implementation, server/computing device 102 includes at least one processor 202 coupled to a system memory 204, as shown in FIG. 2. System memory 204 includes computer program modules 206 and program data 208. In this implementation program modules 206 may include selection module 210, lottery module 212, analysis module 214, and other program modules 216 such as an operating system, device drivers, etc. Each program module 210 through 216 may include a respective set of computer-program instructions executable by processor(s) 202. This is one example of a set of program modules and other numbers and arrangements of program modules are contemplated as a function of the particular arbitrary design and/or architecture of server/computing device 102 and/or system 100 (FIG. 1). Additionally, although shown on a single server/computing device 102, the operations associated with respective computer-program instructions in the program modules 206 could be distributed across multiple computing devices. Program data 208 may include statistical data 220, user data 222, selection data 224, and other program data 226 such as data input(s), third party data, and/or so on.

Embodiments of the present invention may provide systems and methods of playing a lottery game of chance where one or more statistical performances of teams, portions of a team, or players in one or more specific contests, such as sporting events, may be used to determine a winner of the lottery game of chance. In certain embodiments, selections by a participant of the one or more statistical performances of teams, portions of teams, or players may be converted to numbers for the lottery game of chance. One or more winners and/or one or more prizes may be determined by the quantity of correct choices of each participant.

The prizes to be awarded to winning participants of the lottery game and the probabilities of success of the lottery game may be determined by a statistical model that runs various simulations to indicate the outcome of numerous possible selection scenarios. It may be possible to have no overall winners of a top prize in a given time period. The prize money for that time period with no overall winner may then be added to the prize money for a subsequent time period as in traditional jackpot lottery games.

For illustrative purposes only, the description herein refers to sporting events, such as football or baseball. Sporting events may be used on any level, but are preferably related to collegiate and professional sporting events. Examples of sporting events may include, but are not limited to, football, basketball, baseball, hockey, car racing, horse and other animal racing, golf, soccer, tennis, rugby, cricket, jai-alai, hurling, lacrosse, martial arts, Olympic events, extreme sporting events, etc. Preferably, exclusive contracts are signed with leagues, teams, individuals, etc. for rights to use trademarks, logos, player names, etc.

In certain embodiments, participants must select the most productive player, portion of a team or team, as the case may be, across a number of categories from contests to be played within the same day, week, season, post-season, etc. as appropriate. Other non-sports types of contests may also be included in the scope of the invention, such as, for example, academic contests, poker competitions, etc.

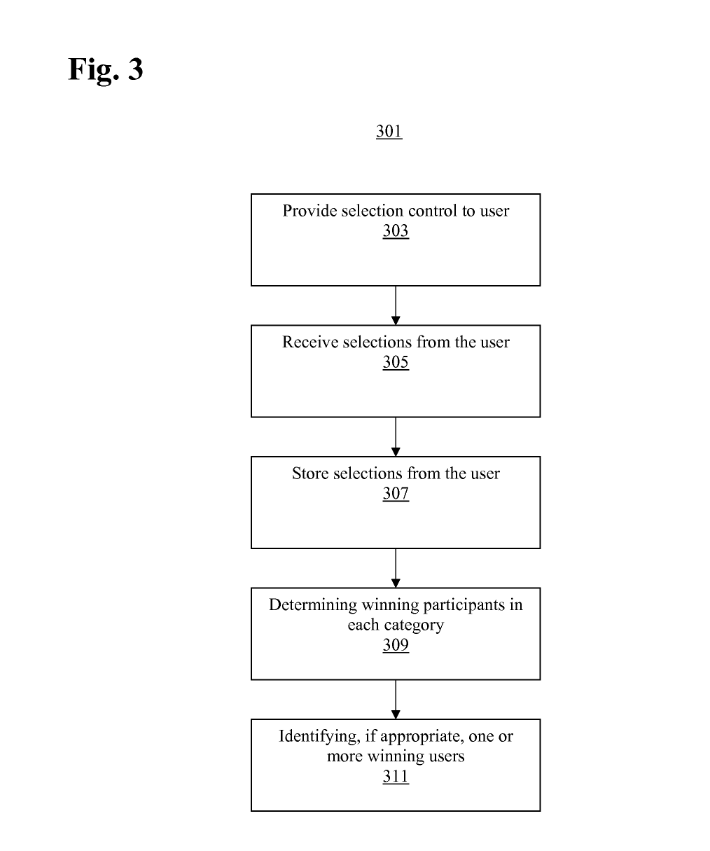

FIG. 3 illustrates an exemplary method that may be used for a combination lottery and fantasy sports league 301. Initially, a user may access a website or other source of the combination lottery and fantasy sports league, and the system may provide a selection control 303. The user may access the selection control through a browser, downloaded software or other system. The accessing may be performed in real-time or near real-time. The system may be a unified web-based selection management system providing selection control between, for example, a web browser and an application server via a hypertext transport protocol (HTTP) connection on an Internet Protocol (IP) network. The application server may execute the web application by runtime execution of a first set of extensible markup language (XML) documents that define the web application to be executed. The application server may generate an HTML form specifying selected application parameters from an XML document executable by the selection management system. The HTML form may be supplied to a browser, enabling a user of the browser to input or modify application parameters for the corresponding XML document into the form. The HTML form may be accessed on personal computers, tablet or pad computers and/or mobile devices.

The HTML form may specify certain activities and statistical performances within sporting events that are identified, selected and separated into one or more categories. The likely participants in the identified categories in such collegiate or professional sporting events may be identified, with typically between 1 and 32 such participants being identified, and listed by their known names. In alternate embodiments, the Montana method for number assignment using a two digit city or team code corresponding to the team the participant plays for along with another two digit code for the participant's jersey number, which may be used to uniquely identify participants. Each likely participant may be assigned a number that equates in total to the number of identified participants. This may allow for flexibility in always uniquely identifying a participant without limiting the number of participants available.

Users may browse among the group of identified participants in each category, and select one of the identified participants in each category. In alternative embodiments, it may be possible to select more than one participant in each category with combined scoring for each participant being weighted or ranked. Furthermore, in other embodiments, there may not be any fixed number of likely participants, and users may select from any active participant in a category during the time period. This would allow for differing numbers of participants due to injuries and other factors.

One or more databases of information regarding sports players, teams, etc. may be provided for use by the user. For example, a user may access a database of player information prior to making a selection of a sports player for a particular category. The system may also provide access to historical statistical data, commentary, analysis, top picks by experts or other users, predictions, etc. about player performance.

Embodiments of the present invention may provide for interactions with social media, such as FACEBOOK, TWITTER, GOOGLE+, etc. Selections and/or results may be posted to social media sites, as well as invitations to join games, groups or leagues.

The system may receive one or more selections from the user 305. Preferably, the user may select one identified participant in each category. The application server may insert the received input application parameters into the XML document, and store the document 307, such as in a database.

If authorized by the laws of the user's state, the user can execute and consummate the transaction with the state lottery online through the selection management system. If necessary, users may print the XML document at any printer connected to a personal computer or network. Users may take their printed XML documents to an authorized state lottery retailer. The retailer may scan the user's printed XML documents and accept payment for a lottery ticket.

After the conclusion of the sporting events, the best achievement by a participant in each category is identified. The participant, and its assigned number, is designated the “winner” 309. The number of “winners” selected by a user determines the user's success in the lottery game. None, one, or more than one winning user may be determined 311.

In certain embodiments, users and/or administrators can create a group or league and invite other users to join the group or league. Users can join multiple groups or leagues.

Lottery prize money may be distributed in various manners. In certain embodiments, there is a main lottery prize (jackpot), and secondary prizes. In an exemplary system, 45% of a wager may be put towards a jackpot with the remaining money going to the organizer, such as a state lottery agency. If secondary prizes are available, the 45% may be split between the jackpot and secondary prizes, which may be predetermined and based on odds of success. Statistical models may be used to estimate odds and payouts based on historical data. A statistical model of betting behavior may be used to set a range of outcomes to calculate expected odds of winning. In certain embodiments, a minimum guaranteed prize may be provided regardless of the amount of wagers made by users.

The main lottery prize may be received by one or more users that correctly pick the winning selection in each category. If there are multiple winning users, the jackpot may be split evenly. If there are no winners, the user with the highest score may get a certain fraction of the jackpot, such as 10% and the remaining money is added to the total jackpot for the following period. If a user matches less than all of the winning selections in each category, secondary prizes may be available, such as picking 5 of 6 correctly. For example, 5 of 6 correct may receive $250,000, 4 of 6 correct may receive $10,000, 3 of 6 correct may receive $150, 2 of 2 correct may receive $10, and 1 of 1 correct may receive $7. The amount of secondary prizes may be determined based on statistical probabilities of success for each secondary prize level. A statistical model may run various simulations to indicate the outcome of numerous possible selection scenarios.

For group or league play, a percentage of the available lottery prize money or a flat fee may be allocated to the winner of each group or league. For example, if 45% of wagers are set aside for prizes, 35% may be reserved for jackpot winners with the remaining 10% being provided to group or league winners. Alternatively, a group or league winner may receive a flat fee of $10,000. Alternatively, the group or league winner prize may be a percentage of the wagers for that group or league. The contestant within the group with the highest point total for a given week or season, as the case may be, is the recipient of the group prize money.

### EXAMPLE 1

### Football

As an example, for a professional football game, a participant may access a web-based application from a browser. A user may then choose from a list of various statistical measurements, which may be related to a position on the football team and/or all or a portion of the football team. Positions may include quarterback, running back, receiver, kicker, linebacker, special teams returner, etc., as well as a list of categories, such as most total yards (offense), most total points (offense), fewest yards allowed (defense) and fewest points allowed (defense). The lists may be alphabetized and each listing may correlate to a specific number or other unique player identification (1-Arizona, Kevin Kolb; 2-Atlanta, Matt Ryan, 3-Baltimore, Joe Flacco; and so on). Thus, as contestants select their players or teams, they may also be selecting a number or other unique player identification. The grouping of the selected numbers may become the user's lottery playslip or roster. The application may save the user's choices and allow the user to print the playslip or roster on a conventional printer. The printed playslip or roster may be accepted at terminals at authorized state lottery retailers. If authorized by state law, players can execute and consummate the transaction with the state lottery online through the selection management system.

### EXAMPLE 2

### Baseball

In certain embodiments, baseball may be used as a game for state lotteries. The game may involve, for example, one or more player categories, preferably six or more categories. A user must select a player in each of the one or more categories. Categories may be based on a position that the sports player plays. The lottery game may be played over a set period, such as a week starting Thursday morning and ending with the last game played on Wednesday. Other time periods include months, seasons, post-seasons, etc. Users may select one or more players, but preferably only one player in each category for the time period. Preferably, rosters must be set at least a set time before the first activity of the time period. In certain embodiments, the player categories may be: Outfield (OF), First Base (1B), Third Base (3B), Middle Infield (MI), Catcher (C) and Pitching/Team Defense (P/TD). Other categories may be used as well. For each category there may be one or more ways a player may accumulate points for the user based on the performance of the player. In an exemplary embodiment, offensive player categories may have scoring categories and values as follows in Table 1.

TABLE 1
Offensive Scoring

| Scoring Category | Value |
|---|---|
| Hits + Walks (H + BB) | 1 pt for every 2 |
| Runs Batted In (RBI) | 1 pt each |
| Runs (R) | 1 pt each |
| Home Run (HR) | 2 pts each |
| Stolen Base (SB) | 4 pts each |
| Caught Stealing (CS) | −1 pt each |

The points for each scoring category may be determined based on averages from historical data, such that that the maximum number of points an average player could get in any one category is a set amount, such as about 5 points. Obviously, exceptional players, particularly in HR or SB, could get more than 5 points in a week.

A Pitching/Team Defense category may also have scoring categories based on averages from historical data, such that the maximum number of points in a category is a set amount, such as about 5. In an exemplary embodiment, the scoring categories and values may be as follows in Table 2.

TABLE 2
Pitching/Team Defense Scoring

| Scoring Category | Value | |
|---|---|---|
| Wins (W) | 1.5 pt each | |
| Saves (S) | 3 pts each | |
| Strikeouts (K) | 1 pt for every 10 | |
| Runs Allowed (R) | 0-15 | 5 pts |
| | 16-20 | 3 pts |
| | 21-24 | 1 pt |
| | 28-31 | −1 pt |
| | 32-36 | −3 pts |
| | 37+ | −5 pts |
| Hits + Walks (H + BB) | 0-49 | 5 pts |
| | 40-60 | 3 pts |
| | 61-68 | 1 pt |
| | 74-81 | −1 pt |
| | 82-92 | −3 pts |
| | 93+ | −5 pts |

| | |
|---|---|
| Error (E) | −1 pt each |

Partial scores may be allowed in certain scoring categories, such as the offensive H+BB category and in the Strikeouts category. Therefore, if a player gets 27 hits and walks then the player will be credited with 13.5 points. Similarly, if a team gets 97 strikeouts, then they will be credited with 9.7 points.

The object of the game is may be to correctly select the winning player in each of the six categories. If there is a tie in an offensive category (such as OF, 1B, 3B, MI, C) then the tie may be broken by looking at the total of RBI+R, or another statistical measurement. If there is a tie in a defensive category (such as Pitching/Team Defense) then the tie may be broken by looking at the raw total of Runs Allowed rather than the point total, or other appropriate statistical measurements. If there is still a tie in any category then the tie may be broken by looking at the alternative statistical measurements, such as raw total of Hits+Walks allowed for defensive purposes. If there are any ties remaining after a predetermined number of statistical measurements are compared, multiple winners may be allowed.

Correctly selecting the winner as defined above in all six categories may entitle the user to a share of the jackpot. If the user is the only winner then the user may receive the entire jackpot. If there are multiple winners, then the jackpot may be split evenly among the multiple winners. The jackpot may be determined as a percentage of the money wagered on the game for the time period.

There may be fixed secondary prizes for choosing the winning player in 5 out of 6 categories and for choosing the winning player in 4 out of 6 categories, etc.

If there is no jackpot winner (no one chose the winning player in all 6 categories), then the user with the highest point total for the six categories may win a prize, such as 10% of the jackpot or a set monetary amount. If there a multiple users with the highest point total then the 10% may be split evenly among them. This insures that there may be one relatively big prize winner every time period.

Although the foregoing description is directed to the preferred embodiments of the invention, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated above.

What is claimed is:

1. A method of determining lottery results, the method comprising:
receiving selections for multiple participant categories from a user, wherein the multiple participant categories are related to one or more statistical performance measurements for a participant in a future sporting event;
converting the selections into numerical lottery numbers;
comparing the numerical lottery numbers to one or more actual statistical performances for each of the multiple participant categories after a sporting event, wherein points in each of the multiple participant categories are assigned based on the one or more actual statistical performances to determine the winning participant, and wherein a maximum number of points an average participant achieves in each of the multiple participant categories is a predetermined amount;
determining, by at least one processor and based on the comparing, if there is at least one winner among all users; and
assigning at least one prize to the at least one winner among all users if there is at least one winner.

2. The method of claim 1, wherein the user is a member of a group or league created by a user or administrator, wherein the group or league is a subset of all users, wherein the subset is less than the total number of users.

3. The method of claim 2, further comprising determining, based on the comparing, if there is at least one winner within the group or league.

4. The method of claim 3, further comprising assigning at least one prize within the group or league if there is at least one winner.

5. The method of claim 1, wherein the points for each of the multiple participant categories are determined based on averages from historical data.

6. The method of claim 1, wherein the multiple participant categories are related to individual sports player positions, portions of sports teams or a sports team.

7. The method of claim 1, wherein the selections are individual sports players, portions of sports teams or a sports team.

8. A method of determining lottery results, the method comprising:
receiving selections for multiple participant categories from a user, wherein the multiple participant categories are related to one or more statistical performance measurements for a participant in a future sporting event, and wherein more than one participant is selected for at least one participant category;
converting the selections into numerical lottery numbers;
comparing the numerical lottery numbers to one or more actual statistical performances for each of the multiple participant categories after a sporting event, wherein points in each of the multiple participant categories are assigned based on the one or more actual statistical performances to determine the winning participant, and wherein combined actual statistical performances for participant categories with more than one participant are combined by weighting and ranking;
determining, by at least one processor and based on the comparing, if there is at least one winner among all users; and
assigning at least one prize to the at least one winner among all users if there is at least one winner.

9. The method of claim 8, wherein the user is a member of a group or league created by a user or administrator, wherein the group or league is a subset of all users, wherein the subset is less than the total number of users.

10. The method of claim 9, further comprising determining, based on the comparing, if there is at least one winner within the group or league.

11. The method of claim 10, further comprising assigning at least one prize within the group or league if there is at least one winner.

12. The method of claim 8, wherein the points for each of the multiple participant categories are determined based on averages from historical data.

13. The method of claim 8, wherein more than one participant is selected for each of the one or more participant categories.

14. A method of determining lottery results, the method comprising:
receiving selections for multiple participant categories from a user, wherein the multiple participant categories are related to one or more statistical performance measurements for a participant in a future sporting event;
converting the selections into numerical lottery numbers;
comparing the numerical lottery numbers to one or more actual statistical performances for each of the multiple participant categories after a sporting event, wherein points in each of the multiple participant categories are assigned based on the one or more actual statistical performances to determine the winning participant;
determining, by at least one processor and based on the comparing, if there is at least one winner among all users; and
assigning at least one prize to the at least one winner among all users if there is at least one winner, wherein the at least one prize is determined by a statistical model.

15. The method of claim 14, wherein the user is a member of a group or league created by a user or administrator, wherein the group or league is a subset of all users, wherein the subset is less than the total number of users, further comprising determining, based on the comparing, if there is at least one winner within the group or league, further comprising assigning at least one prize within the group or league if there is at least one winner.

16. The method of claim 14, wherein a monetary amount of the at least one prize is determined by the statistical model.

17. The method of claim 14, wherein the statistical model is a simulation indicating outcomes of numerous possible selection scenarios.

18. The method of claim 14, wherein the at least one prize is a secondary prize.

19. The method of claim 14, further comprising determining statistical probability of success for the at least one prize using a statistical model.

20. The method of claim 19, further comprising determining statistical probability of success for more than one prize using a statistical model.
